(19) United States
(12) Patent Application Publication
(10) Pub. No.: US 2013/0189417 A1
(43) Pub. Date: Jul. 25, 2013

(54) COFFEE FORMULATION

(71) Applicant: The Healthy Cafe LLC, Lake Arrowhead, CA (US)

(72) Inventor: Casey Fasullo-Nachtrieb, Twin Peaks, CA (US)

(73) Assignee: The Healthy Cafe LLC, Lake Arrowhead, CA (US)

(21) Appl. No.: 13/733,073

(22) Filed: Jan. 2, 2013

Related U.S. Application Data
(60) Provisional application No. 61/631,324, filed on Jan. 3, 2012.

(51) Int. Cl. A23F 5/26

(52) U.S. Cl. CPC A23F 5/267
USPC 426/595; 426/433; 426/594; 426/392; 426/385

(57) ABSTRACT

In an aspect, a roasted coffee composition, a brewed roasted coffee product, and a method of preparing the brewed roasted coffee product is provided.

### CROSS-REFERENCE TO RELATED APPLICATION

This application claims priority to and the benefit of U.S. Provisional Application No. 61/631,324 filed Jan. 3, 2012, the disclosure of which is incorporated in its entirety herein by reference.

### BACKGROUND

1. Field

This disclosure relates to a roasted coffee composition, a brewed roasted coffee product, and a method of preparing the brewed roasted coffee product.

2. Description of the Related Technology

Coffee is a brewed beverage that is made from roasted coffee beans whose beans come primarily from Robusta coffee plants and Arabica coffee plants. Arabica coffee beans come from Arabica plants (Coffea arabica), grown in semitropical climates near the equator, both in the western and eastern hemispheres, at high altitudes. For example, Brazil and Colombia are the two largest countries for commercial Arabica coffee bean production. Robusta coffee beans come from Robusta plants (Coffea canephora), which are grown in Southeast Asia, Africa and Brazil. They thrive in equatorial climates, but at low altitudes. Their cherries require less care than Arabica cherries since they remain on the tree after they ripen. Robusta beans have twice the caffeine of Arabica coffee beans but less flavor and more bitter characteristics than Arabica. Robusta beans (before roasting) conjure smells of oats or peanuts, with a grainy and nutty fragrance. Coffee made from Robusta beans has a strong, harsh, spicy earthy flavor taste, with a grain-like overtone and peanutty aftertaste. Robusta trees, however, are easier to grow than Arabica coffee plants. They can grow at lower altitudes than Arabicas, and they are less vulnerable to pests and weather conditions. They produce fruit much more quickly than the Arabicas, which need several years to come to maturity, and they yield more crop per tree. Therefore Robusta can be significantly cheaper than Arabica.

Lower priced brands of coffee over the years have experimented with adding Robusta to their Arabica blends to reduce production costs. Arabica coffee has a sweeter, softer taste, with tones of sugar, fruit, and berries thus it is difficult to use the harsher tasting Robusta with Arabica without compromising the overall quality taste of the blend. The coffee industry for years has been trying to develop methods to improve the taste aspects of Robusta but thus far no method has proven commercially successful.

In order to obtain a liquid beverage coffee typically is brewed at a high temperature. In 2002, scientists in Sweden announced the discovery of acrylamide in a variety of heated foods. Further research subsequently determined that acrylamide can form in some foods during certain types of high-temperature cooking. Acrylamide in food is a concern because it has been found to be carcinogenic in rodents and is therefore considered a potential carcinogen for humans.

Since the identification of acrylamide in food, research around the world has centered on measuring acrylamide exposure in the diet, studying the toxicology and epidemiology of acrylamide exposure, and reducing (mitigating) acrylamide levels in food. Although the EPA regulates acrylamide levels in drinking water to protect public health, the FDA has not issued guidance for manufacturers on reducing acrylamide levels in food. However it is probable that new information will soon be available about the toxicology of acrylamide, which may confirm acrylamide's carcinogenicity in laboratory animals. Moreover, the FDA is aware that at least some manufacturers in the United States are seeking ways to reduce acrylamide in their products. For these reasons, the FDA is considering issuing guidance for the industry on allowable acrylamide levels in food products.

Acrylamide has been observed in food products that have been through an elevated temperature heat cycle, for frying or baking above 120° C. under low moisture conditions. Acrylamide has been observed in some fruit and vegetable products heated at lower temperatures or higher moisture conditions. Also, acrylamide has been observed primarily in plant-based foods such as crackers, breakfast cereals, french fries, potato chips, coffee, cookies, and toasted bread.

Based on measured levels of acrylamide in certain foods and on how frequently these foods are consumed in the United States, the FDA identified the following foods (in ranked order) that contribute the most acrylamide to the U.S. diet: French fries (restaurant prepared), French fries (oven baked), potato chips, breakfast cereals, cookies, brewed coffee, toast, pies and cakes, crackers, and soft (nontoasted) breads. The Joint FAO/WHO Expert Committee on Food Additives concurred with the FDA conclusion.

Research on acrylamide mitigation has focused on reducing acrylamide in potato products, cereal-grain-based products (e.g., baked goods), and coffee through interventions directed at raw materials, additional ingredients, and processing. As a result of this research, effective mitigation measures have been identified for reducing acrylamide levels in some potato and cereal products; however, no proven mitigation measures have been devised for coffee. (Federal Register, Volume 74 Issue 164, Aug. 26, 2009).

Methods of acrylamide reduction for coffee focused on treating the coffee beans before roasting has met with some success, but in most cases the methodology is too costly for commercial production. Numerous roasting techniques have been tried to reduce acrylamides but none have proven effective.

### SUMMARY

Provided are methods for reducing the level of acrylamide in brewed coffee. In one embodiment, the method comprises adding an herbal mixture to roasted coffee before brewing. In another embodiment, the method comprises adding an extract of an herbal mixture to a brewed coffee product. In some such methods, the amount of acrylamide present in the herbal mixture-added brewed coffee product is lower than the amount of acrylamide present in a brewed coffee product brewed under the same brewing conditions with the same coffee to which the herbal mixture is not added. Also provided are methods for making a lowered acrylamide coffee beverage having a taste on par with or better than the unmodified coffee beverage.

Also provided herein are coffee products that contain coffee and an herbal mixture. In one embodiment, provided is an unbrewed coffee composition comprising roasted, unbrewed coffee and an herbal mixture. In another embodiment, provided is a brewed coffee composition comprising brewed coffee and an extract of an herbal mixture. In some such brewed and unbrewed coffee compositions, the amount of acrylamide present in the herbal mixture-added coffee product, after brewing, is lower than the amount of acrylamide present in a brewed coffee product brewed under the same brewing conditions with the same coffee to which the herbal mixture is not present. Also provided coffee products with lowered acrylamide levels that have a taste on par with or better than the unmodified coffee product.

Some embodiments provide an acrylamide-reducing coffee composition comprising: roasted unbrewed coffee and an herbal blend, wherein the acrylamide-reducing coffee composition may be characterized in that, when the acrylamide-reducing coffee composition is brewed to form a reduced acrylamide brewed coffee product, the amount of acrylamide present in the reduced acrylamide brewed coffee product may be at least 10% lower than the amount of acrylamide present in a brewed coffee product brewed from the same coffee under the same brewing conditions wherein the herbal blend is not added.

Some embodiments provide a process for reducing the level of acrylamide in a brewed roasted coffee product, comprising: providing a coffee bean to be roasted; roasting the coffee bean to form roasted coffee; adding an herbal blend to the roasted coffee before brewing the roasted coffee; and brewing the herbal blend-added roasted coffee to form a reduced acrylamide brewed coffee product, wherein the amount of acrylamide present in the reduced acrylamide brewed coffee product may be at least 10% lower than the amount of acrylamide present in a brewed coffee product brewed from the same roasted coffee under the same brewing conditions wherein the herbal blend is not added.

Some embodiments provide a reduced acrylamide brewed coffee product comprising: a high temperature aqueous extraction components of roasted coffee; and a high temperature aqueous extraction components of an herbal blend, wherein the amount of acrylamide present in the reduced acrylamide brewed coffee product may be at least 10% lower than the amount of acrylamide present in a brewed coffee product that differs from the reduced acrylamide brewed coffee product only by not containing the high temperature aqueous extraction components of an herbal blend.

Some embodiments provide a process for reducing the level of acrylamide in a brewed roasted coffee product, comprising: brewing an herbal blend to form a brewed herbal blend product; brewing a roasted coffee to form a brewed coffee product; and combining the roasted coffee or the brewed coffee product with the herbal blend or the brewed herbal blend product to form a reduced acrylamide brewed coffee product, wherein the amount of acrylamide present in the reduced acrylamide brewed coffee product may be at least 10% lower than the amount of acrylamide present in a brewed coffee product brewed from the same roasted coffee under the same brewing conditions wherein the herbal blend is not added.

In some embodiments of a process as disclosed and described herein, the roasted coffee and the herbal blend may be combined prior to brewing either the roasted coffee or the herbal blend, and the combined roasted coffee and herbal blend may be brewed together. In some embodiments, the roasted coffee and herbal blend may be brewed separately, and the brewed coffee product may be combined with the brewed herbal blend product. In some embodiments of a process as disclosed and described herein the roasted coffee may be brewed to form a brewed coffee product and the herbal blend may be brewed using the brewed coffee product. In some embodiments of a process as disclosed and described herein, the herbal blend may be brewed to form a brewed herbal blend product and the roasted coffee maybe brewed using the brewed herbal blend product.

In some embodiments of a process or composition as disclosed and described herein, the herbal blend comprises cacao, and at least one selected from the group consisting of sambucus, rosehips, hibiscus, and ziziphus fruit. In some embodiments of a process or composition as disclosed and described herein, the herbal blend comprises at least 20% by weight cacao ; and at least 0.003% by weight of one selected from the group consisting of sambucus, rosehips, hibiscus, and ziziphus fruit. In some embodiments of a process or composition as disclosed and described herein, the herbal blend comprises a first herbal component selected from cacao, barley, rice, gelatin, and a combination thereof; and a second herbal component selected from the group consisting of sambucus, rosehips, hibiscus, ziziphus fruit, and a combination thereof. In some embodiments of a process or composition as disclosed and described herein, the herbal blend comprises at least 20% by weight of a first herbal component selected from cacao, barley, rice, gelatin, and a combination thereof; and at least 0.003% by weight of a one second herbal component selected from the group consisting of sambucus, rosehips, hibiscus, ziziphus fruit, and a combination thereof. In some embodiments of a process or composition as disclosed and described herein, the herbal blend or brewed herbal blend product may be in contact with the roasted coffee or brewed roasted coffee product in an aqueous solvent at a temperature ranging from 50 to 100° C. for at least 1 to 10 minutes. In some embodiments of a process or composition as disclosed and described herein, the composition does not include more than 15%, 10%, 8%, or 6% black or red tea by weight. In some embodiments of a process or composition as disclosed and described herein, the composition does not include more than 10%, 8%, 7%, 6%, or 5% cinnamon by weight. In some embodiments of a process or compositions as disclosed and described herein, the roasted unbrewed coffee may be robusta coffee. In some embodiments of a process or compositions as disclosed and described herein, the roasted unbrewed coffee is arabica coffee. In some embodiments of a process or compositions as disclosed and described herein, the roasted unbrewed coffee may be a blend of robusta and arabica coffee, wherein, the amount of robusta coffee in the blend of robusta and arabica coffee is at least 5%, 10%, 20%, 30%, 40%, 50%, 60%, 70%, 80%, 90%, or 95% by weight. In some embodiments of a process or composition as disclosed and described herein, the roasted unbrewed coffee comprises whole bean roasted coffee. In some embodiments of a process or composition as disclosed and described herein, the roasted unbrewed coffee comprises ground roasted coffee. In some embodiments of a process or composition as disclosed and described herein, the coffee composition coffee comprises at least 3%, 4%, 5%, 6%, 7%, 8%, 9%, 10%, 11%, 12%, 13%, 14%, or 15% by weight cacao. In some embodiments of a process or composition as disclosed and described herein, the cacao may be a cacao extract, and the amount of extract is the dry, unextracted weight equivalent. In some embodiments of a process or composition as disclosed and described herein, the coffee composition coffee comprises at least 0.5%, 0.7%, 1.0%, 1.5%, 2.0%, 2.5%, 3.0%, or 3.5% by weight sambucus. In some embodiments of a process or composition as disclosed and described herein, the sambucus may be a sambucus extract, and the amount of extract is the dry, unextracted weight equivalent.

In some embodiments of a process or composition as disclosed and described herein, the coffee composition coffee comprises at least 0.5%, 0.7%, 1.0%, 1.5%, 2.0%, 2.5%, 3.0%, or 3.5% by weight rosehips. In some embodiments, the rosehips may be a rosehips extract, and the amount of extract is the dry, unextracted weight equivalent.

In some embodiments of a process or composition as disclosed and described herein, the coffee composition coffee comprises at least 0.5%, 0.7%, 1.0%, 1.5%, 2.0%, 2.5%, 3.0%, or 3.5% by weight hibiscus. In some embodiments, the hibiscus may be a hibiscus extract, and the amount of extract is the dry, unextracted weight equivalent.

In some embodiments of a process or composition as disclosed and described herein, the coffee composition coffee comprises at least 0.5%, 0.7%, 1.0%, 1.5%, 2.0%, 2.5%, 3.0%, or 3.5% by weight ziziphus fruit. In some embodiments, the ziziphus fruit may be a ziziphus fruit extract, and the amount of extract is the dry, unextracted weight equivalent.

In some embodiments of a process or composition as disclosed and described herein, the coffee composition further comprises one or more herbs selected from the group consisting of Astragulus Root, Barley, Black Tea, Cardamon Pods, Cinnamon, Cloves, Star Anise, Nutmeg, English Breakfast Tea, Earl Grey Tea, Gelatin, Green Tea, Ginger root, Ginseng, Honeybush, Jasmine Flower, Lavender flower, Lemon Balm, Lemon Grass, Licorice root, Logan Fruit, Lotus Seed, Orange Peel, Passion Flower, Peppermint, Rice, Pomegranite, Rose, Sencha, Spearmint, Stevia Leaf and Valerian Root. In some embodiments of a process or composition as disclosed and described herein, the acrylamide-reducing coffee composition is characterized in that, when the acrylamide-reducing coffee composition may be brewed to form a reduced acrylamide brewed coffee product, the amount of acrylamide present in the reduced acrylamide brewed coffee product is at least 15%, 20%, 25%, 30%, 35%, 40%, 45%, or 50%, lower than the amount of acrylamide present in a brewed coffee product brewed from the same coffee wherein the herbal blend is not added. In some embodiments of a process or composition as disclosed and described herein, the reduced acrylamide brewed coffee product may be placed in a container configured for immediate consumption. In some embodiments of a process or composition as disclosed and described herein, the reduced acrylamide brewed coffee product may be placed in a sealed container configured to store the reduced acrylamide brewed coffee product for at least one week. In some embodiments of a process or composition as disclosed and described herein, the reduced acrylamide brewed coffee product may be freeze dried or spray dried.

Also provided are methods for making Robusta coffee into a coffee beverage having a taste on par with or better than most Arabica ground coffee beverages. For example, provided herein are methods for brewing Robusta coffee that includes adding an herbal mixture. In one embodiment, the method comprises adding an herbal mixture to a roasted Robusta coffee before brewing. In another embodiment, the method comprises adding an extract of an herbal mixture to a brewed Robusta coffee product.

Also provided Robusta coffees having a taste on par with or better than most Arabica ground coffee beverages. For example, provided herein are coffee products that contain Robusta coffee and an herbal mixture. In one embodiment, provided is an unbrewed coffee composition comprising roasted, unbrewed Robusta coffee and an herbal mixture. In another embodiment, provided is a brewed coffee composition comprising brewed Robusta coffee and an extract of an herbal mixture.

Some embodiments provide a coffee composition comprising: 55% or more by weight roasted unbrewed coffee by weight; at least 3% by weight cacao ; and at least 0.5% by weight of an herbal component selected from the group consisting of sambucus, rosehips, hibiscus, ziziphus fruit, and a combination thereof.

Some embodiments provide a coffee composition comprising: 55% or more by weight roasted unbrewed coffee by weight; at least 3% by weight of a first herbal component selected from cacao, barley, rice, gelatin, and a combination thereof; and at least 0.5% by weight of a second herbal component selected from the group consisting of sambucus, rosehips, hibiscus, ziziphus fruit, and a combination thereof.

In some embodiments of a composition as disclosed and described herein, the composition does not include more than 15%, 10%, 8%, or 6% black or red tea by weight. In some embodiments of a composition as disclosed and described herein, the composition does not include more than 10%, 8%, 7%, 6%, or 5% cinnamon by weight. In some embodiments of a composition as disclosed and described herein, the roasted unbrewed coffee may be robusta coffee. In some embodiments of a composition as disclosed and described herein, the roasted unbrewed coffee may be arabica coffee. In some embodiments of a composition as disclosed and described herein, the roasted unbrewed coffee may be a blend of robusta and arabica coffee, wherein, the amount of robusta coffee in the blend of robusta and arabica coffee is at least 5%, 10%, 20%, 30%, 40%, 50%, 60%, 70%, 80%, 90%, or 95% by weight. In some embodiments of a composition as disclosed and described herein, the roasted unbrewed coffee comprises ground roasted coffee. In some embodiments of a composition as disclosed and described herein, the roasted unbrewed coffee comprises ground roasted coffee.

In some embodiments of a composition as disclosed and described herein, the coffee composition coffee comprises at least 3%, 4%, 5%, 6%, 7%, 8%, 9%, 10%, 11%, 12%, 13%, 14%, or 15% by weight cacao. In some embodiments, the cacao may be a cacao extract, and the amount of extract is the dry, unextracted weight equivalent.

In some embodiments of a composition as disclosed and described herein, the coffee composition coffee comprises at least 0.5%, 0.7%, 1.0%, 1.5%, 2.0%, 2.5%, 3.0%, or 3.5% by weight sambucus. In some embodiments, the sambucus may be a sambucus extract, and the amount of extract is the dry, unextracted weight equivalent.

In some embodiments of a composition as disclosed and described herein, the coffee composition coffee comprises at least 0.1%, 0.2%, 0.3%, 0.4%, 0.5%, 0.7%, 1.0%, 1.5%, 2.0%, 2.5%, 3.0%, or 3.5% by weight rosehips. In some embodiments, the rosehips may be a rosehips extract, and the amount of extract is the dry, unextracted weight equivalent.

In some embodiments of a composition as disclosed and described herein, the coffee composition coffee comprises at least 0.5%, 0.7%, 1.0%, 1.5%, 2.0%, 2.5%, 3.0%, or 3.5% by weight hibiscus. In some embodiments, the hibiscus may be a hibiscus extract, and the amount of extract is the dry, unextracted weight equivalent.

In some embodiments of a composition as disclosed and described herein, the coffee composition coffee comprises at least 0.5%, 0.7%, 1.0%, 1.5%, 2.0%, 2.5%, 3.0%, or 3.5% by weight ziziphus fruit. In some embodiments, the ziziphus fruit may be a ziziphus fruit extract, and the amount of extract is the dry, unextracted weight equivalent.

In some embodiments of a composition as disclosed and described herein, the coffee composition further comprises one or more herbs selected from the group consisting of Astragulus Root, Barley, Black Tea, Cardamon Pods, Cinnamon, Cloves, Star Anise, Nutmeg, English Breakfast Tea, Earl Grey Tea, Gelatin, Green Tea, Ginger root, Ginseng, Honeybush, Jasmine Flower, Lavender flower, Lemon Balm, Lemon Grass, Licorice root, Logan Fruit, Lotus Seed, Orange Peel, Passion Flower, Peppermint, Rice, Pomegranite, Rose, Sencha, Spearmint, Stevia Leaf and Valerian Root.

Some embodiments provide a process for brewing a roasted coffee, comprising: providing a coffee composition as disclosed and described herein; brewing the coffee composition to form a brewed coffee product.

Some embodiments provide a brewed coffee product comprising: a high temperature aqueous extraction components of roasted coffee; and a high temperature aqueous extraction components of an herbal blend, wherein the herbal blend comprises at least 20% by weight cacao ; and at least 0.003% by weight of one selected from the group consisting of sambucus, rosehips, hibiscus, and ziziphus fruit.

Some embodiments provide a process for a brewing a roasted coffee, comprising: brewing an herbal blend to form a brewed herbal blend product, wherein the herbal blend comprises at least 20% by weight cacao ; and at least 0.003% by weight of one selected from the group consisting of sambucus, rosehips, hibiscus, and ziziphus fruit; brewing a roasted coffee to form a brewed coffee product; and combining the roasted coffee or the brewed coffee product with the herbal blend or the brewed herbal blend product to form a brewed coffee product. In some embodiments, the roasted coffee and the herbal blend may be combined prior to brewing either the roasted coffee or the herbal blend, and the combined roasted coffee and herbal blend are brewed together. In some embodiments, the roasted coffee and herbal blend may be brewed separately, and the brewed coffee product may be combined with the brewed herbal blend product. In some embodiments, the roasted coffee may be brewed to form a brewed coffee product and the herbal blend maybe brewed using the brewed coffee product. In some embodiments, the herbal blend may be brewed to form a brewed herbal blend product and the roasted coffee may be brewed using the brewed herbal blend product.

In some embodiments of a process as disclosed and described herein, the herbal blend or brewed herbal blend product may be in contact with the roasted coffee or brewed roasted coffee product in an aqueous solvent at a temperature ranging from 50 to 100° C. for at least 1 to 10 minutes.

Some embodiments provide a brewed coffee product from the process as disclosed and described herein.

In some embodiments of a process or composition as disclosed and described herein, the brewed coffee product may be placed in a container configured for immediate consumption. In some embodiments of a process or composition as disclosed and described herein, the brewed coffee product may be placed in a sealed container configured to store the brewed coffee product for at least one week. In some embodiments of a process or composition as disclosed and described herein, the brewed coffee product may be freeze dried or spray dried.

All documents cited herein are, in relevant part, incorporated herein by reference; the citation of any document is not to be construed as an admission that it is prior art.

### DETAILED DESCRIPTION

Provided herein are coffee products that contain coffee and an herbal mixture. In one embodiment, provided is an unbrewed coffee composition comprising roasted, unbrewed coffee and an herbal mixture. In another embodiment, provided is a brewed coffee composition comprising brewed coffee and an extract of an herbal mixture. In some such brewed and unbrewed coffee compositions, the amount of acrylamide present in the herbal mixture-added coffee product, after brewing, is lower than the amount of acrylamide present in a brewed coffee product brewed under the same brewing conditions with the same coffee to which the herbal mixture is not present. In some embodiments, provided are Robusta coffees having a taste on par with most Arabica ground coffee beverages. For example, provided herein are coffee products that contain Robusta coffee and an herbal mixture. In one embodiment, provided is an unbrewed coffee composition comprising roasted, unbrewed Robusta coffee and an herbal mixture. In another embodiment, provided is a brewed coffee composition comprising brewed Robusta coffee and an extract of an herbal mixture.

Also provided are methods for making coffee products that contain a combination of coffee and an herbal mixture.

### Coffee Compositions

The coffee compositions provided herein comprise coffee and at least one herb. In some embodiments, the coffee compositions provided herein comprise coffee and a combination of two or more herbs.

In some embodiments, the coffee can include whole coffee beans. In some embodiments, the coffee can include ground beans. In some embodiments, the coffee can include whole coffee beans and ground coffee beans. In some embodiments, the coffee can include a course grind of ground beans. In some embodiments, the coffee is roasted. In some embodiments, the coffee is Arabica coffee. In some embodiments, the coffee is Robusta coffee. In some embodiments, the coffee is a blend of Arabica and Robusta coffee. For example, the coffee can be roasted ground Robusta coffee, roasted ground Arabica coffee, roasted whole Robusta coffee beans, roasted whole Arabica coffee beans, a blend of roasted ground Robusta coffee and roasted ground Arabica, a blend of roasted whole Robusta coffee beans and roasted whole Arabica beans, roasted course ground Robusta coffee, roasted course ground Arabica coffee, and a blend of roasted course ground Robusta coffee and roasted course ground Arabica.

In some embodiments, the composition includes 40% or more unbrewed roasted coffee by weight. In some embodiments, the composition includes 45% or more unbrewed roasted coffee by weight. In some embodiments, the composition includes 50% or more unbrewed roasted coffee by weight. In some embodiments, the composition includes 55% or more unbrewed roasted coffee by weight. In some embodiments, the composition includes 60% or more unbrewed roasted coffee by weight. In some embodiments, the composition includes 65% or more unbrewed roasted coffee by weight. In some embodiments, the composition includes 70% or more unbrewed roasted coffee by weight. In some embodiments, the composition includes 75% or more unbrewed roasted coffee by weight. In some embodiments, the composition includes 80% or more unbrewed roasted coffee by weight. In some embodiments, the composition includes 85% or more unbrewed roasted coffee by weight. In some embodiments, the composition includes 90% or more unbrewed roasted coffee by weight. In some embodiments, the composition includes 95% or more unbrewed roasted coffee by weight. In some embodiments, the composition includes 96% or more unbrewed roasted coffee by weight. In some embodiments, the composition includes 97% or more unbrewed roasted coffee by weight. In some embodiments, the composition includes 98% or more unbrewed roasted coffee by weight. In some embodiments, the composition includes 99% or more unbrewed roasted coffee by weight.

In some embodiments, the composition includes no more than 95% or more unbrewed roasted coffee by weight. In some embodiments, the composition includes no more than 90% or more unbrewed roasted coffee by weight. In some embodiments, the composition includes no more than 85% or more unbrewed roasted coffee by weight. In some embodiments, the composition includes no more than 80% or more unbrewed roasted coffee by weight. In some embodiments, the composition includes no more than 75% or more unbrewed roasted coffee by weight. In some embodiments, the composition includes no more than 70% or more unbrewed roasted coffee by weight. In some embodiments, the composition includes no more than 65% or more unbrewed roasted coffee by weight. In some embodiments, the composition includes no more than 60% or more unbrewed roasted coffee by weight.

In some embodiments, at least 5% of the unbrewed roasted coffee is Robusta coffee. In some embodiments, at least 10% of the unbrewed roasted coffee is Robusta coffee. In some embodiments, at least 15% of the unbrewed roasted coffee is Robusta coffee. In some embodiments, at least 20% of the unbrewed roasted coffee is Robusta coffee. In some embodiments, at least 25% of the unbrewed roasted coffee is Robusta coffee. In some embodiments, at least 30% of the unbrewed roasted coffee is Robusta coffee. In some embodiments, at least 35% of the unbrewed roasted coffee is Robusta coffee. In some embodiments, at least 40% of the unbrewed roasted coffee is Robusta coffee. In some embodiments, at least 45% of the unbrewed roasted coffee is Robusta coffee. In some embodiments, at least 50% of the unbrewed roasted coffee is Robusta coffee. In some embodiments, at least 55% of the unbrewed roasted coffee is Robusta coffee. In some embodiments, at least 60% of the unbrewed roasted coffee is Robusta coffee. In some embodiments, at least 65% of the unbrewed roasted coffee is Robusta coffee. In some embodiments, at least 70% of the unbrewed roasted coffee is Robusta coffee. In some embodiments, at least 75% of the unbrewed roasted coffee is Robusta coffee. In some embodiments, at least 80% of the unbrewed roasted coffee is Robusta coffee. In some embodiments, at least 85% of the unbrewed roasted coffee is Robusta coffee. In some embodiments, at least 90% of the unbrewed roasted coffee is Robusta coffee. In some embodiments, at least 95% of the unbrewed roasted coffee is Robusta coffee. In some embodiments, substantially all of the unbrewed roasted coffee is Robusta coffee.

The coffee composition comprises coffee and one or more herbs or extracts of one or more herbs. In some embodiments, the coffee composition comprises coffee and two or more herbs or extracts of two or more herbs. In some embodiments, the one or more herbs combined with the coffee is selected from Astragulus Root, Barley, Black Tea, Cacao, Cardamon Pods, Cinnamon, Cloves, Star Anise, Nutmeg, English Breakfast Tea, Earl Grey Tea, Gelatin, Green Tea, Ginger root, Ginseng, Hibiscus, Hibiscus flower, Honeybush, Jasmine Flower, Lavender flower, Lemon Balm, Lemon Grass, Licorice root, Logan Fruit, Lotus Seed, Orange Peel, Passion Flower, Peppermint, Rice, Pomegranite, Rose, Rosehips, ziziphus fruit, Sambucus, Sencha, Spearmint, Stevia Leaf and Valerian Root. In some embodiments, the coffee composition comprises coffee and cacao or a cacao extract. In some embodiments, the coffee composition comprises coffee and at least one herb selected from cacao, rice, barley, gelatin, and extracts thereof. In some embodiments, the coffee composition comprises coffee and at least one herb selected from cacao, sambucus, rosehips, hibiscus, ziziphus fruit, and extracts thereof. In some embodiments, the coffee composition comprises coffee and at least one herb selected from cacao, rice, barley, gelatin, sambucus, rosehips, hibiscus, ziziphus fruit, and extracts thereof. In some embodiments, the coffee composition comprises coffee and at least two herbs selected from cacao, sambucus, rosehips, hibiscus, ziziphus fruit, and extracts thereof. In some embodiments, the coffee composition comprises coffee and at least two herbs selected from cacao, rice, barley, gelatin, sambucus, rosehips, hibiscus, ziziphus fruit, and extracts thereof. In some embodiments, the coffee composition comprises coffee and cacao, and further comprises at least one herb selected from sambucus, rosehips, hibiscus, ziziphus fruit, and extracts thereof. In some embodiments, the coffee composition comprises coffee and at least one first herb selected from cacao, rice, barley, gelatin, and extracts thereof, and further comprises at least one second herb selected from sambucus, rosehips, hibiscus, ziziphus fruit, and extracts thereof.

The herb extracts referred to include decoctions, tinctures, distillates, aqueous extracts, ethanol extracts, and other products of the herb used in the art that maintain the properties of the non-extracted herb. It will be understood that when an herb extract is used, a lesser quantity of the herb extract can be included in a coffee composition compared to the quantity of the non-extract herb that would otherwise be included in the coffee composition. In this sense, the herb extract provides a concentrate of the non-extracted herb. The degree of concentration of the herb in a particular extract is known in the art, or is readily determined using routine methods. Thus, a given quantity of an herb extract will correspond to a readily determined quantity of a dry, non-extracted herb. In some embodiments, the herb extract will correspond to about a 10-fold larger quantity of dry, non-extracted herb. In some embodiments, the herb extract will correspond to about a 20-fold larger quantity of dry, non-extracted herb. In some embodiments, the herb extract will correspond to about a 30-fold larger quantity of dry, non-extracted herb. In some embodiments, the herb extract will correspond to about a 40-fold larger quantity of dry, non-extracted herb. In some embodiments, the herb extract will correspond to about a 50-fold larger quantity of dry, non-extracted herb. In some embodiments, the herb extract will correspond to about a 60-fold larger quantity of dry, non-extracted herb. In some embodiments, the herb extract will correspond to about a 70-fold larger quantity of dry, non-extracted herb. In some embodiments, the herb extract will correspond to about a 80-fold larger quantity of dry, non-extracted herb. In some embodiments, the herb extract will correspond to about a 90-fold larger quantity of dry, non-extracted herb. In some embodiments, the herb extract will correspond to about a 100-fold larger quantity of dry, non-extracted herb.

Unless indicated otherwise, the quantities of an herb recited herein refer to the quantity of dry, non-extracted herb. Notwithstanding the recitation of quantities of an herb as the quantity of dry, non-extracted herb, it is contemplated that an herb extract also can be used, and the quantity of the herb extract used is the quantity of herb extract that corresponds to the recited quantity of dry, non-extracted herb. That is, when an extract of the herb is used, the actual quantity of herbal extract may be far less than the corresponding quantity of dry, non-extracted herb; however, the actual quantity of herbal extract used is the quantity of herbal extract that corresponds to the recited quantity reflects the quantity of dry, non-extracted herb. Thus, for example, when 1 gram of an herb extract corresponds to 50 grams of dry, non-extracted herb, a coffee composition that contains 5% by weight of the dry, non-extracted herb is equal to a coffee composition that contains 0.1% of the herb extract. Accordingly, recitation of a coffee composition containing 5% by weight of the dry, non-extracted herb also encompasses a coffee composition containing 0.1% by weight of the 50-fold concentrated extract.

Cacao is a product of the seed of Theobroma cacao. In some embodiments the cacao is raw. In some embodiments the cacao is fermented. In some embodiments the cacao is roasted. In some embodiments the cacao is fermented and roasted. In some embodiments, the cacao includes cacao nibs. In some embodiments the cacao is ground. In some embodiments the cacao includes ground cacao nibs. In some embodiments the cacao is ground and maintains at least part of the shell. In some embodiments the cacao may be roasted, ground and maintains at least part of the shell. In some embodiments the cacao may be fermented, roasted, ground and maintains at least part of the shell. In some embodiments, the cacao has not been substantially processed beyond the cacao nib stage. A cacao that has not been substantially processed beyond the cacao nib stage is a cacao that has not undergone significant physical separation of components present at the cacao nib stage, and has not undergone a process that significantly modifies the chemical components present at the cacao nib stage. For example, a cacao that has not been substantially processed beyond the cacao nib stage can be a cacao that has not undergone a physical separation of components such that the physical composition of the cacao is more than 20%, 10% or 5% modified relative to the physical composition of cacao nibs. For example, the cacao has not been pressed and subject to a significant physical separation of cacao solids from cacao lipids or other cacao liquids. In another example, a cacao that has not been substantially processed beyond the cacao nib stage can be a cacao that has not undergone a process that modifies the chemical components such that the chemical composition of the cacao is more than 20%, 10% or 5% modified relative to the chemical composition of cacao nibs. For example, the cacao has not been heated or contacted with one or more reagents that results in a significant modification of the alkaloid or flavanoid composition of the cacao. An example of a cacoa that has not undergone a process that significantly modifies the chemical components present at the cacao nib stage is ground cacao mass, which is a ground form of cacao nibs. Other examples of cacao that have not undergone a process that significantly modifies the chemical components present at the cacao nib stage include sliced and cut cacao nibs. In some embodiments, a cacao extract is used. Cacao extracts that can be used include cacao powder, tincture, alcohol extract, aqueous extract or decoction. Cacao extracts not suitable for use in the present blends include cocao liquor, cocoa butter. In some embodiments, cacao compositions not suitable for use in the present blends include processed products containing cocao liquor, cocoa butter, such as confectioner's chocolate, unless such products also contain cacao nibs or a cacao that has not undergone a process that significantly modifies the chemical components present at the cacao nib stage.

In some embodiments, the composition includes 0.01% or more cacao by weight. In some embodiments, the composition includes 1% or more cacao by weight. In some embodiments, the composition includes 5% or more cacao by weight. In some embodiments, the composition includes no more than 10% cacao by weight. In some embodiments, the composition includes no more than 20% cacao by weight. In some embodiments, the composition includes no more than 25% cacao by weight. In some embodiments, the composition includes from about 0.01% to about 40% cacao by weight. In some embodiments, the composition includes from about 0.1% to about 35% cacao by weight. In some embodiments, the composition includes from about 1% to about 30% cacao by weight. In some embodiments, the composition includes from 2% to 20% cacao by weight. In some embodiments, the composition includes from 4% to 15% cacao by weight. In some embodiments, the composition includes at least 0.01%, 0.1%, 1%, 2%, 3%, 5%, 10%, 15%, 20%, 25%, 30%, 35%, or 40% cacao by weight, or a range defined by any two of the preceding values. In some embodiments, the composition includes cacao extract corresponding to at least 0.01%, 0.1%, 1%, 2%, 3%, 5%, 10%, 15%, 20%, 25%, 30%, 35%, or 40% dry, unextracted cacao by weight, or a range defined by any two of the preceding values.

The Sambucus or Elderberry used in the present compositions and methods includes one or more parts of a plant of the Sambucus genus, and extract(s) of any part of a plant of the Sambucus genus. In some embodiments, the Sambucus includes a berry portion. In some embodiments, the Sambucus includes a berry portion, an extract of a berry portion or combination thereof. In some embodiments, the Sambucus includes a flower portion. In some embodiments, the Sambucus includes a flower portion, an extract of a flower portion or combination thereof. In some embodiments, the Sambucus includes a leaf portion. In some embodiments, the Sambucus includes a leaf portion, an extract of a leaf portion or combination thereof. In some embodiments, the Sambucus includes a stem portion. In some embodiments, the Sambucus includes a stem portion, an extract of a stem portion or combination thereof. In some embodiments, the Sambucus includes a root portion. In some embodiments, the Sambucus includes a root portion, an extract of a root portion or combination thereof. In some embodiments, the Sambucus includes a combination of two or more, three or more, or four or more of a berry portion, an extract of a berry portion, a flower portion, an extract of a flower portion, a leaf portion, an extract of a leaf portion, a stem portion, an extract of a stem portion, a root portion, and an extract of a root portion. In some embodiments, the Sambucus is ground. In some embodiments, the Sambucus may include the whole berry portion or fruit portion. In some embodiments, the Sambucus is in the form of a powder. In some embodiments the Sambucus is dried. In some embodiments the Sambucus is dried and ground. In some embodiments, the Sambucus is dried and in the form of a powder. In some embodiments, the Sambucus is dried and in whole form.

In some embodiments, the composition includes 0.01% or more Sambucus by weight. In some embodiments, the composition includes 1% or more Sambucus by weight. In some embodiments, the composition includes 5% or more Sambucus by weight. In some embodiments, the composition includes no more than 10% Sambucus by weight. In some embodiments, the composition includes no more than 15% Sambucus by weight. In some embodiments, the composition includes no more than 20% Sambucus by weight. In some embodiments, the composition includes no more than 25% Sambucus by weight. In some embodiments, the composition includes no more than 30% Sambucus by weight. In some embodiments, the composition includes no more than 35% Sambucus by weight. In some embodiments, the composition includes from about 0.01% to about 35% Sambucus by weight. In some embodiments, the composition includes from about 0.1% to about 30% Sambucus by weight. In some embodiments, the composition includes from about 1% to about 25% Sambucus by weight. In some embodiments, the composition includes from about 1% to about 5% Sambucus by weight. In some embodiments, the composition includes from about 5% to about 10% Sambucus by weight. In some embodiments, the composition includes from about 10% to about 20% Sambucus by weight. In some embodiments, the composition includes from about 20% to about 30% Sambucus by weight. In some embodiments, the composition includes from about 30% to about 35% Sambucus by weight. In some embodiments, the composition includes at least 0.01%, 0.1%, 1%, 2%, 3%, 5%, 10%, 15%, 20%, 25%, 30%, 35%, or 40% Sambucus by weight, or a range defined by any two of the preceding values. In some embodiments, the composition includes Sambucus extract corresponding to at least 0.01%, 0.1%, 1%, 2%, 3%, 5%, 10%, 15%, 20%, 25%, 30%, 35%, or 40% dry, non-extracted Sambucus by weight, or a range defined by any two of the preceding values.

The Hibiscus used in the present compositions and methods includes one or more parts of a plant of the Hibiscus genus, and extract(s) of any part of a plant of the Hibiscus genus. In some embodiments, the Hibiscus includes a fruit portion. In some embodiments the Hibiscus includes a fruit portion, an extract of a fruit portion or combination thereof. In some embodiments the Hibiscus includes a leaf portion. In some embodiments, the Hibiscus includes a flower portion. In some embodiments the Hibiscus includes a flower portion, an extract of a flower portion or combination thereof. In some embodiments the Hibiscus includes a leaf portion. In some embodiments the Hibiscus includes a leaf portion, an extract of a leaf portion or combination thereof. In some embodiments the Hibiscus includes a stem portion. In some embodiments the Hibiscus includes a stem portion, an extract of a stem portion or combination thereof. In some embodiments the Hibiscus includes a root portion. In some embodiments the Hibiscus includes a root portion, an extract of a root portion or combination thereof. In some embodiments, the Hibiscus includes a combination of two or more, three or more, or four or more of a fruit portion, an extract of a fruit portion, flower portion, an extract of a flower portion, a leaf portion, an extract of a leaf portion, a stem portion, an extract of a stem portion, a root portion, and an extract of a root portion. In some embodiments, the Hibiscus is ground. In some embodiments, the Hibiscus is in the form of a powder. In some embodiments the Hibiscus is dried. In some embodiments the Hibiscus is dried and ground. In some embodiments, the Hibiscus is dried and in the form of a powder.

In some embodiments, the composition includes 0.01% or more Hibiscus by weight. In some embodiments, the composition includes 1% or more Hibiscus by weight. In some embodiments, the composition includes 5% or more Hibiscus by weight. In some embodiments, the composition includes no more than 10% Hibiscus by weight. In some embodiments, the composition includes no more than 12% Hibiscus by weight. In some embodiments, the composition includes no more than 15% Hibiscus by weight. In some embodiments, the composition includes from about 0.01% to about 15% Hibiscus by weight. In some embodiments, the composition includes from about 0.1% to about 12% Hibiscus by weight. In some embodiments, the composition includes from about 1% to about 10% Hibiscus by weight. In some embodiments, the composition includes at least 0.01%, 0.1%, 1%, 2%, 3%, 4%, 5%, 6%, 7%, 8%, 9%, 10%, or 15% Hibiscus by weight, or a range defined by any two of the preceding values. In some embodiments, the composition includes Hibiscus extract corresponding to at least 0.01%, 0.1%, 1%, 2%, 3%, 4%, 5%, 6%, 7%, 8%, 9%, 10%, or 15% dry, non-extracted Hibiscus by weight, or a range defined by any two of the preceding values.

The rose hip used in the present compositions and methods includes a fruit of a plant of the Rosa genus, and an extract of the fruit of a plant of the Rosa genus. In some embodiments the rose hip is dried. In some embodiments the rose hip is ground. In some embodiments the rose hip is dried and ground. In some embodiments, the rose hip is in the form of a powder. In some embodiments, the rose hip is dried and in the form of a powder.

In some embodiments, the composition includes 0.001% or more rose hips by weight. In some embodiments, the composition includes 0.1% or more rose hips by weight. In some embodiments, the composition includes 1% or more rose hips by weight. In some embodiments, the composition includes 5% or more rose hips by weight. In some embodiments, the composition includes 10% or more rose hips by weight. In some embodiments, the composition includes 15% or more rose hips by weight. In some embodiments, the composition includes no more than 5% rose hips by weight. In some embodiments, the composition includes no more than 10% rose hips by weight. In some embodiments, the composition includes no more than 15% rose hips by weight. In some embodiments, the composition includes no more than 20% rose hips by weight. In some embodiments, the composition includes no more than 25% rose hips by weight. In some embodiments, the composition includes no more than 30% rose hips by weight. In some embodiments, the composition includes from about 0.001% to about 30% rose hips by weight. In some embodiments, the composition includes from about 0.001% to about 30% rose hips by weight. In some embodiments, the composition includes from about 0.1% to about 25% rose hips by weight. In some embodiments, the composition includes at least 0.001%, 0.1%, 1%, 2%, 3%, 4%, 5%, 6%, 7%, 8%, 9%, 10%, or 15% rose hips by weight, or a range defined by any two of the preceding values. In some embodiments, the composition includes 0.00001% or more rose hips extract by weight. In some embodiments, the composition includes rose hips extract corresponding to at least 0.001%, 0.1%, 1%, 2%, 3%, 4%, 5%, 6%, 7%, 8%, 9%, 10%, or 15% dry, non-extracted rose hips by weight, or a range defined by any two of the preceding values.

The Ziziphus fruit used in the present compositions and methods includes a fruit of a plant of the Ziziphus genus, and an extract of a plant or portion of a plant of the Ziziphus genus. In some embodiments the Ziziphus fruit may be dried. In some embodiments the Ziziphus fruit may be ground. In some embodiments the Ziziphus fruit may be dried and ground. In some embodiments, the Ziziphus fruit may be in the form of a powder. In some embodiments, the Ziziphus fruit may be dried and in the form of a powder.

In some embodiments, the composition includes 0.01% or more Ziziphus fruit by weight. In some embodiments, the composition includes 0.1% or more Ziziphus fruit by weight. In some embodiments, the composition includes 1% or more Ziziphus fruit by weight. In some embodiments, the composition includes 5% or more Ziziphus fruit by weight. In some embodiments, the composition includes no more than 10% Ziziphus fruit by weight. In some embodiments, the composition includes no more than 15% Ziziphus fruit by weight. In some embodiments, the composition includes no more than 20% Ziziphus fruit by weight. In some embodiments, the composition includes no more than 25% Ziziphus fruit by weight. In some embodiments, the composition includes from about 0.01% to about 25% Ziziphus fruit by weight. In some embodiments, the composition includes from about 0.1% to about 20% Ziziphus fruit by weight. In some embodiments, the composition includes from about 1% to about 15% Ziziphus fruit by weight. In some embodiments, the composition includes at least 0.01%, 0.1%, 1%, 2%, 3%, 5%, 10%, 15%, 20%, or 25% Ziziphus fruit by weight, or a range defined by any two of the preceding values. In some embodiments, the composition includes Ziziphus fruit extract corresponding to at least 0.01%, 0.1%, 1%, 2%, 3%, 5%, 10%, 15%, 20%, or 25% dry, non-extracted Ziziphus fruit by weight, or a range defined by any two of the preceding values.

In some embodiments, one or more additional herbs can be used in the coffee compositions and methods provided herein. The one or more additional herbs can be selected from Astragulus Root, Barley, Black Tea, Cardamon Pods, Cinnamon, Cloves, Star Anise, Nutmeg, English Breakfast Tea, Earl Grey Tea, Gelatin, Green Tea, Ginger root, Ginseng, Honeybush, Jasmine Flower, Lavender flower, Lemon Balm, Lemon Grass, Licorice root, Logan Fruit, Lotus Seed, Orange Peel, Passion Flower, Peppermint, Rice, Pomegranite, Rose, Sencha, Spearmint, Stevia Leaf and Valerian Root. In some embodiments, the herb includes a fruit portion. In some embodiments the herb includes a fruit portion, an extract of a fruit portion or combination thereof. In some embodiments, the herb includes a flower portion. In some embodiments the herb includes a flower portion, an extract of a flower portion or combination thereof. In some embodiments, the herb includes a seed portion. In some embodiments the herb includes a seed portion, an extract of a seed portion or combination thereof. In some embodiments the herb includes a leaf portion. In some embodiments the herb includes a leaf portion, an extract of a leaf portion or combination thereof. In some embodiments the herb includes a stem portion. In some embodiments the herb includes a stem portion, an extract of a stem portion or combination thereof. In some embodiments the herb includes a root portion. In some embodiments the herb includes a root portion, an extract of a root portion or combination thereof. In some embodiments, the herb includes a combination of two or more, three or more, or four or more of a fruit portion, an extract of a fruit portion, a flower portion, an extract of a flower portion, a seed portion, an extract of a seed portion, a leaf portion, an extract of a leaf portion, a stem portion, an extract of a stem portion, a root portion, and an extract of a root portion. In some embodiments, the herb is ground. In some embodiments, the herb is in the form of a powder. In some embodiments the herb is dried. In some embodiments the herb is dried and ground. In some embodiments, the herb is dried and in the form of a powder. In some embodiments, the composition may include a dried, whole, sliced, roasted, baked or fresh herb or combination of thereof. In some embodiments, the herb may be dried. In some embodiments, the herb may be whole. In some embodiments, the herb may be sliced. In some embodiments, the herb may be roasted. In some embodiments, the herb may be baked. In some embodiments, the herb may be fresh.

In some embodiments, the composition includes 0.01% or more of any one of the above-described herbs by weight. In some embodiments, the composition includes 1% or more of any one of the above-described herbs by weight. In some embodiments, the composition includes 5% or more of any one of the above-described herbs by weight. In some embodiments, the composition includes 10% or more of any one of the above-described herbs by weight. In some embodiments, the composition includes 20% or more of any one of the above-described herbs by weight. In some embodiments, the composition includes 30% or more of any one of the above-described herbs by weight. In some embodiments, the composition includes no more than 10% of any one of the above-described herbs by weight. In some embodiments, the composition includes no more than 20% of any one of the above-described herbs by weight. In some embodiments, the composition includes no more than 25% of any one of the above-described herbs by weight. In some embodiments, the composition includes from about 0.01% to about 25% of any one of the above-described herbs by weight. In some embodiments, the composition includes from about 0.1% to about 20% of any one of the above-described herbs by weight. In some embodiments, the composition includes from about 1% to about 15% of any one of the above-described herbs by weight. In some embodiments, the composition includes at least 0.01%, 0.1%, 1%, 2%, 3%, 5%, 10%, 15%, 20%, or 25% of any one of the above-described herbs weight, or a range defined by any two of the preceding values. In some embodiments, the composition includes an extract of any one of the above-described herbs corresponding to at least 0.01%, 0.1%, 1%, 2%, 3%, 5%, 10%, 15%, 20%, or 25% of the same dry, non-extracted herb by weight, or a range defined by any two of the preceding values.

In some embodiments, the composition includes at least 0.1% black or red tea by weight. In some embodiments, the composition includes from about 0.1% to about 15% black or red tea by weight. In some embodiments, the composition includes at least 0.01%, 0.1%, 1%, 2%, 3%, 4%, 5%, 6%, 7%, 8%, 9%, 10%, or 15% black or red tea by weight, or a range defined by any two of the preceding values. In some embodiments, the composition does not include more than 15%, 12%, 10%, 8%, 7%, 6%, 5%, 4%, or 3% black or red tea by weight. In some embodiments, the composition includes at least 0.1% cinnamon by weight. In some embodiments, the composition includes from about 0.1% to about 10% cinnamon by weight. In some embodiments, the composition includes at least 0.01%, 0.1%, 1%, 2%, 3%, 4%, 5%, 6%, 7%, 8%, 9%, 10%, or 15% cinnamon by weight, or a range defined by any two of the preceding values. In some embodiments, the composition does not include more than 15%, 12%, 10%, 8%, 7%, 6%, 5%, 4%, or 3% cinnamon by weight.

In some embodiments, the coffee composition comprises 60% to 85% decaffeinated coffee and 15% to 40% herb blend. In some embodiments, the coffee composition comprises 70% to 80% decaffeinated coffee and 20% to 30% herb blend. Examples of such herb blends include 10% to 20% cacao, 0 to 20% elderberry, 0 to 10% cinnamon, 0 to 5% rosehips, where the percentage of each herb is the weight percent of the herb in the entire coffee composition (with coffee added). Additional examples of such herb blends include 10% to 17% cacao, 2% to 12% elderberry, 0 to 5% cinnamon, 0 to 5% rosehips. In another example, another herb blend includes 10% to 17% cacao, 5% to 10% elderberry, 0.5 to 2% cinnamon, 0.2 to 2% rosehips.

In some embodiments, the coffee composition comprises 70% to 96% Robusta coffee and 4% to 30% herb blend. In some embodiments, the coffee composition comprises 85% to 95% Robusta coffee and 5% to 15% herb blend. Examples of such herb blends include 1% to 10% cacao, 0 to 10% elderberry, 0 to 10% cinnamon, 0 to 8% rosehips, 0 to 10% hibiscus, where the percentage of each herb is the weight percent of the herb in the entire coffee composition (with coffee added). Additional examples of such herb blends include 2% to 8% cacao, 0% to 5% elderberry, 0 to 5% cinnamon, 0 to 5% rosehips, 0 to 5% hibiscus. For example, another herb blend includes 3 to 8% cacao, 0.5 to 4% cinnamon, and 0.5 to 4% rosehips. In another example, another herb blend includes 6 to 9% cacao, 0.5 to 3% Hibiscus, and 0.5 to 4% rosehips. In another example, another herb blend includes 3 to 10% cacao, 0.1 to 4% cinnamon, 0.1 to 3% Hibiscus, and 0.1 to 4% rosehips.

In some embodiments, the coffee composition comprises 65% to 95% Arabica coffee and 5% to 35% herb blend. In some embodiments, the coffee composition comprises 70% to 80% Arabica coffee and 20% to 30% herb blend. Examples of such herb blends include 10% to 20% cacao, 0 to 20% elderberry, 0 to 10% cinnamon, 0 to 5% rosehips, where the percentage of each herb is the weight percent of the herb in the entire coffee composition (with coffee added). Additional examples of such herb blends include 10% to 15% cacao, 2% to 12% elderberry, 0 to 10% cinnamon, 0 to 5% rosehips. In another example, another herb blend includes 10% to 15% cacao, 5% to 10% elderberry, 0.5 to 2% cinnamon, 0.2 to 2% rosehips.

In some embodiments, the coffee composition comprises 79% to 95% Folgers coffee and 5% to 21% herb blend. In some embodiments, the coffee composition comprises 85% to 95% Folgers coffee and 15% to 5% herb blend. Examples of such herb blends include 1% to 15% cacao, 0 to 15% elderberry, 0 to 10% cinnamon, 0 to 10% rosehips, where the percentage of each herb is the weight percent of the herb in the entire coffee composition (with coffee added). Additional examples of such herb blends include 1% to 8% cacao, 0% to 5% elderberry, 0 to 4% cinnamon, and 0 to 4% rosehips. In another example, another herb blend includes 1% to 8% cacao, 1% to 5% elderberry, 0.5 to 4% cinnamon, and 0.2 to 3% rosehips.

In some embodiments, the coffee composition comprises 75% to 95% Maxwell House coffee and 5% to 25% herb blend. In some embodiments, the coffee composition comprises 76% to 85% Maxwell House coffee and 24% to 15% herb blend. Examples of such herb blends include 1% to 15% cacao, 1% to 15% elderberry, 0 to 10% cinnamon, 0 to 5% rosehips, where the percentage of each herb is the weight percent of the herb in the entire coffee composition (with coffee added). Additional examples of such herb blends include 5% to 15% cacao, 2% to 12% elderberry, 0 to 5% cinnamon, and 0 to 5% rosehips. In another example, another herb blend includes 5% to 15% cacao, 5% to 10% elderberry, 0.5 to 5% cinnamon, and 0 to 5% rosehips.

In some embodiments, the coffee composition comprises 79% to 95% Starbucks coffee and 5% to 21% herb blend. In some embodiments, the coffee composition comprises 85% to 95% Starbucks coffee and 15% to 5% herb blend. Examples of such herb blends include 1% to 15% cacao, 0 to 15% elderberry, 0 to 10% cinnamon, 0 to 10% rosehips, where the percentage of each herb is the weight percent of the herb in the entire coffee composition (with coffee added). Additional examples of such herb blends include 1% to 8% cacao, 0% to 5% elderberry, 0 to 4% cinnamon, and 0 to 4% rosehips. In another example, another herb blend includes 3% to 8% cacao, 1% to 5% elderberry, 0.2 to 4% cinnamon, and 0 to 4% rosehips.

In some embodiments, herb blends are used, where the herb blends or aqueous extracts thereof are added to the coffee or an aqueous extract thereof. The amount of an herb used in the herb blend can be reported in terms of the weight amount of dry, unextracted herb relative to the entire coffee composition. Alternatively, the amount of an herb used in the herb blend can be reported in terms of the weight amount of dry, unextracted herb relative to only the herb component of the composition. When reported in terms of the weight amount of dry, unextracted herb relative to only the herb component of the composition, the amount of cacao can be at least 20%, 30%, 40%, 50%, 60%, 70%, 80%, 90% or 95% of the herb blend. In some embodiments, the amount of cacao in the herb blend can be no more than 98%, 95%, 90%, 85%, 80%, 75%, 70%, 65%, 60%, 55%, 50%, or 45% of the herb blend. When reported in terms of the weight amount of dry, unextracted herb relative to only the herb component of the composition, the amount of sambucus can be at least 0.5%, 1%, 2%, 3%, 4%, 5%, 6%, 7%. 8%, 9%, 10%, 11%, 12%, 13%, 14%, 15%, 20%, 25%, 30%, 35%, 40%, 45% or 50% of the herb blend. In some embodiments, the amount of sambucus in the herb blend can be no more than 70%, 65%, 60%, 55%, 50%, 45%, 40%, 35%, 30%, 25%, 20%, 15%, 10% or 5% of the herb blend. When reported in terms of the weight amount of dry, unextracted herb relative to only the herb component of the composition, the amount of hibiscus can be at least 0.5%, 1%, 2%, 3%, 4%, 5%, 6%, 7%. 8%, 9%, 10%, 11%, 12%, 13%, 14%, 15%, 20%, 25%, 30%, 35%, 40%, 45% or 50% of the herb blend. In some embodiments, the amount of hibiscus in the herb blend can be no more than 70%, 65%, 60%, 55%, 50%, 45%, 40%, 35%, 30%, 25%, 20%, 15%, 10% or 5% of the herb blend. When reported in terms of the weight amount of dry, unextracted herb relative to only the herb component of the composition, the amount of rosehips can be at least 0.001%, 0.002%, 0.003%, 0.005%, 0.01%, 0.02%, 0.03%. 0.05%, 0.1%, 0.2%, 0.3%, 0.5%, 1%, 1.5%, 2%, 2.5%, 3%, 3.5%, 4%, 4.5% or 5% of the herb blend. In some embodiments, the amount of rosehips in the herb blend can be no more than 7%, 6%, 5%, 4%, 3%, 2%, 1%, 0.5%, 0.2%, 0.1%, or 0.005% of the herb blend. When reported in terms of the weight amount of dry, unextracted herb relative to only the herb component of the composition, the amount of Ziziphus fruit can be at least 0.5%, 1%, 2%, 3%, 4%, 5%, 6%, 7%. 8%, 9%, 10%, 11%, 12%, 13%, 14%, 15%, 20%, 25%, 30%, 35%, 40%, 45% or 50% of the herb blend. In some embodiments, the amount of Ziziphus fruit in the herb blend can be no more than 70%, 65%, 60%, 55%, 50%, 45%, 40%, 35%, 30%, 25%, 20%, 15%, 10% or 5% of the herb blend. When reported in terms of the weight amount of dry, unextracted herb relative to only the herb component of the composition, the amount of additional herbs can be at least 0.5%, 1%, 2%, 3%, 4%, 5%, 6%, 7%. 8%, 9%, 10%, 11%, 12%, 13%, 14%, 15%, 20%, 25%, 30%, 35%, 40%, 45% or 50% of the herb blend. In some embodiments, the amount of additional herbs in the herb blend can be no more than 70%, 65%, 60%, 55%, 50%, 45%, 40%, 35%, 30%, 25%, 20%, 15%, 10% or 5% of the herb blend, where the one or more additional herbs can be selected from Astragulus Root, Barley, Black Tea, Cardamon Pods, Cinnamon, Cloves, Star Anise, Nutmeg, English Breakfast Tea, Earl Grey Tea, Gelatin, Green Tea, Ginger root, Ginseng, Honeybush, Jasmine Flower, Lavender flower, Lemon Balm, Lemon Grass, Licorice root, Logan Fruit, Lotus Seed, Orange Peel, Passion Flower, Peppermint, Rice, Pomegranite, Rose, Sencha, Spearmint, Stevia Leaf and Valerian Root

### Preparation of Coffee Products

The coffee products provided herein may be made by a process including forming a first component by combining dry coffee and a first aqueous component; and heating the first component at a first temperature for a first period of time to provide a second component. The first component may be combined with one or more herbs before or during the first period of time, or combination thereof. The one or more herbs may be in the form of a dry, non-extracted herb or in the form of dry or liquid extracted herb including dilutions of the extract. In some embodiments, the herb extract may include decoctions, tinctures, distillates, aqueous extracts, ethanol extracts, and other products of the herb used in the art that maintain the properties of the non-extracted herb. In some embodiments, the herb extract may be a dilution in an aqueous mixture. For example, the one or more herbs may be combined with an aqueous component and heated at a temperature for a period of time. The mixture or filtrate of the mixture may then be combined with the first aqueous component or the second component and further processed. Thus, in some embodiments, dry herb or an extract thereof, is combined with dry coffee, and the combination is contacted with an aqueous solution, such as the first aqueous component, to provide an aqueous extract of the coffee and the herb, such as the second component. In other embodiments, the herb or extract thereof is contacted with an aqueous solution, such as the first aqueous component, and this solution is subsequently contacted with the dry coffee to provide an aqueous extract of the coffee and the herb, such as the second component. In other embodiments, the dry coffee is contacted with an aqueous solution, such as the first aqueous component, and this solution is subsequently contacted with the herb or extract thereof to provide an aqueous extract of the coffee and the herb, such as the second component. In yet other embodiments, the herb or extract thereof is contacted with an aqueous solution, and this solution is subsequently contacted with an aqueous extract of the dry coffee, such as the second component, to form a third component. In some embodiments, the coffee product may be fresh brewed coffee. In some embodiments, the coffee product is brewed coffee stored for immediate consumption. In some embodiments, the coffee product is combined with one, two, one or more, or two or more, additional ingredients. Examples of additional ingredients include, for example, cream, milk, non-dairy creamer, soy milk, sugar, and non-sugar sweetener. In some embodiments, the coffee product is brewed coffee stored for later consumption. In some embodiments, the coffee product is stored in a sealed container. In some embodiments, the product stored in the sealed container is sterile. In some embodiments, the product stored in the sealed container is configured to store the product for at least 1 day, 3 days, 1 week, 2 weeks, 1 month, 2 months, 3 months, 6 months, or 1 year.

In some embodiments, the dry coffee that is included in the first component can include whole coffee beans. In some embodiments, the dry coffee that is included in the first component can include ground beans. In some embodiments, the dry coffee that is included in the first component can include whole coffee beans and ground coffee beans. In some embodiments, the dry coffee that is included in the first component can include a course grind of ground beans. In some embodiments, the dry coffee that is included in the first component is roasted. In some embodiments, the dry coffee that is included in the first component includes Arabica coffee. In some embodiments, the dry coffee that is included in the first component includes Robusta coffee. In some embodiments, the dry coffee that is included in the first component includes a blend of Arabica and Robusta coffee. In some embodiments, the dry coffee that is included in the first component is a freeze dried blend of Arabica and Robusta coffee. In some embodiments, the dry coffee that is included in the first component is a spray dried blend of Arabica and Robusta coffee. In some embodiments, the dry coffee that is included in the first component is a freeze dried Robusta coffee. In some embodiments, the dry coffee that is included in the first component is a spray dried Robusta coffee. In some embodiments, the dry coffee that is included in the first component is a freeze dried Arabica coffee. In some embodiments, the dry coffee that is included in the first component is a spray dried Arabica coffee.

In some embodiments, the first temperature may be 55° C., 60° C., 65° C., 70° C., 75° C., 80° C., 85° C., 90° C., 95° C., or 100° C. or a temperature in a range defined by any two of the preceding values. In some embodiments, the first period of time may be 5 seconds, 10 seconds, 20 seconds, 30 seconds, 40 seconds, 50 seconds, 1 minute, 1.5 minutes, 2 minutes, 2.5 minutes, 3 minutes, 3.5 minutes, 4 minutes, 5 minutes, 10 minutes, 20 minutes, 30 minutes, 60 minutes, or 120 minutes, or a time in a range defined by any two of the preceding values.

In some embodiments, the process further includes adding one or more herbs to the first component. In some embodiments, the process further includes adding one or more herbs to the second component. In some embodiments, the process further includes forming a third component by combining one or more herbs and a second aqueous component; and heating the third component at a second temperature for a second period of time.

In some embodiments, the second temperature may be 55° C., 60° C., 65° C., 70° C., 75° C., 80° C., 85° C., 90° C., 95° C., or 100° C. or a temperature in a range defined by any two of the preceding values. In some embodiments, the second period of time may be at least, at least about, more than, or more than about, 5 seconds, 10 seconds, 20 seconds, 30 seconds, 40 seconds, 50 seconds, 1 minute, 1.5 minutes, 2 minutes, 2.5 minutes, 3 minutes, 3.5 minutes, 4 minutes, 5 minutes, 10 minutes, 20 minutes, 30 minutes, 60 minutes, or 120 minutes, or a time in a range defined by any two of the preceding values.

In some embodiments, the coffee and one or more herbs may be mixed together to form a mixture and then brewed. For example, the coffee and one or more herbs may be mixed together and then brewed at about 80° C. In some embodiments, it may be advantageous to allow the mixture to move freely during the brewing process. In some embodiments, the mixture is brewed for a minimum of 3 minutes and then strained to afford a coffee product.

The inventor has found that the herb-blended coffee products provided herein possess a taste that is superior to a coffee product from the same coffee, brewed the same way, but to which the herb blend is not added. In some embodiments, evaluation of the taste of a coffee product is determined by a survey of average coffee drinkers. For example, an average coffee drinker can be an individual that typically drinks 1 or more, or 1 to 10, 1 to 5, or 2 to 5 coffee beverages per day. In some embodiments, the herb-blended coffee products provided herein are preferred by at least 50% of average coffee drinkers over a coffee product from the same coffee, brewed the same way, but to which the herb blend is not added. In some embodiments, the herb-blended coffee products provided herein are preferred by at least 55%, 60%, 65%, 70%, 75%, 80%, 85%, or 90% of average coffee drinkers over a coffee product from the same coffee, brewed the same way, but to which the herb blend is not added.

### Acrylamide Reduction In Coffee

The inventor set out to prepare herbal coffee blends of Cacoa Nibs, Elder berries and Cinnamon high in Vitamin A, C, and E and other beneficial nutrients after brewing. Analysis of Vitamin A, C, and E for these coffee blends was conducted, and it was found that less than 25 IU/110G Vitamin A, less than 1 MG/100G Vitamin C, and no Vitamin E were present in the brewed coffee. Accordingly, it was initially concluded that these herbal coffee blends failed to provide a health benefit. However, upon further analysis of the coffee, it was found that the coffee possessed notably low levels of acrylamide. In fact, the herbal coffee blends provided herein, when prepared in accordance with the compositions and methods provided herein, result in lower acrylamide levels than would otherwise result from the same coffee that is not blended with herbs.

Asparagine, a naturally occurring amino acid is present in all types of coffee, which can form acrylamide when heated. Coffees that are richer in asparagines (i.e. Robusta), when heated, tend to contain higher levels of acrylamide. The longer coffee beans are roasted the lower the acrylamide levels (i.e. bold roasts are lower).

Any of the above described herb-blended coffee compositions may be employed in an herbal coffee blend that provides a brewed coffee product where the amount of acrylamide present may be at least 10% lower than the amount of acrylamide present in a brewed coffee product brewed from the same coffee under the same brewing conditions wherein the herbal blend is not added. In some embodiments, the amount of acrylamide present may be from about 10% to about 50% lower than the amount of acrylamide present in a brewed coffee product brewed from the same coffee under the same brewing conditions wherein the herbal blend is not added. In some embodiments, the amount of acrylamide present may be at least 5%, 10%, 15%, 20%, 25%, 30%, 35%, 40%, 45%, 50%, or 55% lower than the amount of acrylamide present in a brewed coffee product brewed from the same coffee under the same brewing conditions wherein the herbal blend is not added, or a range defined by any two of the preceding values.

Some embodiments provide an acrylamide-reducing coffee composition including: roasted unbrewed coffee and an herbal blend, wherein the acrylamide-reducing coffee composition is characterized in that, when the acrylamide-reducing coffee composition is brewed to form a reduced acrylamide brewed coffee product, the amount of acrylamide present in the reduced acrylamide brewed coffee product may be at least 10% lower than the amount of acrylamide present in a brewed coffee product brewed from the same coffee under the same brewing conditions wherein the herbal blend is not added. In some embodiments, the amount of acrylamide present may be at least 50% lower than the amount of acrylamide present in a brewed coffee product brewed from the same coffee under the same brewing conditions wherein the herbal blend is not added. In some embodiments, the amount of acrylamide present may be from about 10% to about 50% lower than the amount of acrylamide present in a brewed coffee product brewed from the same coffee under the same brewing conditions wherein the herbal blend is not added. In some embodiments, the amount of acrylamide present may be at least 5%, 10%, 15%, 20%, 25%, 30%, 35%, 40%, 45%, 50%, or 55% lower than the amount of acrylamide present in a brewed coffee product brewed from the same coffee under the same brewing conditions wherein the herbal blend is not added, or a range defined by any two of the preceding values.

Some embodiments provide a reduced acrylamide brewed coffee product including: a high temperature aqueous extraction components of roasted coffee; and a high temperature aqueous extraction components of an herbal blend, wherein the amount of acrylamide present in the reduced acrylamide brewed coffee product may be at least 10% lower than the amount of acrylamide present in a brewed coffee product that differs from the reduced acrylamide brewed coffee product only by not containing the high temperature aqueous extraction components of an herbal blend. In some embodiments, the amount of acrylamide present may be at least 50% lower than the amount of acrylamide present in a brewed coffee product brewed from the same coffee under the same brewing conditions wherein the herbal blend is not added. In some embodiments, the amount of acrylamide present may be from about 10% to about 50% lower than the amount of acrylamide present in a brewed coffee product brewed from the same coffee under the same brewing conditions wherein the herbal blend is not added. In some embodiments, the amount of acrylamide present may be at least 5%, 10%, 15%, 20%, 25%, 30%, 35%, 40%, 45%, 50%, or 55% lower than the amount of acrylamide present in a brewed coffee product brewed from the same coffee under the same brewing conditions wherein the herbal blend is not added, or a range defined by any two of the preceding values.

Some embodiments provide a process for reducing the level of acrylamide in a brewed roasted coffee product, including: providing a coffee bean to be roasted; roasting the coffee bean to form roasted coffee; adding an herbal blend to the roasted coffee before brewing the roasted coffee; and brewing the herbal blend-added roasted coffee to form a reduced acrylamide brewed coffee product, wherein the amount of acrylamide present in the reduced acrylamide brewed coffee product may be at least 10% lower than the amount of acrylamide present in a brewed coffee product brewed from the same roasted coffee under the same brewing conditions wherein the herbal blend is not added. In some embodiments, the amount of acrylamide present may be at least 50% lower than the amount of acrylamide present in a brewed coffee product brewed from the same coffee under the same brewing conditions wherein the herbal blend is not added. In some embodiments, the amount of acrylamide present may be from about 10% to about 50% lower than the amount of acrylamide present in a brewed coffee product brewed from the same coffee under the same brewing conditions wherein the herbal blend is not added. In some embodiments, the amount of acrylamide present may be at least 5%, 10%, 15%, 20%, 25%, 30%, 35%, 40%, 45%, 50%, or 55% lower than the amount of acrylamide present in a brewed coffee product brewed from the same coffee under the same brewing conditions wherein the herbal blend is not added, or a range defined by any two of the preceding values. In some embodiments of the process, the amount of acrylamide present may be at least 15%, 20%, 25%, 30%, 35%, 40%, 45%, or 50%, lower than the amount of acrylamide present in a brewed coffee product brewed from the same coffee wherein the herbal blend is not added. In some embodiments of the process, the brewing may include heating an aqueous mixture at a temperature of 55° C., 60° C., 65° C., 70° C., 75° C., 80° C., 85° C., 90° C., 95° C., or 100° C. or a temperature in a range defined by any two of the preceding values. In some embodiments of the process, the brewing may include heating an aqueous mixture for a time of at least, at least about, more than, or more than about, 5 seconds, 10 seconds, 20 seconds, 30 seconds, 40 seconds, 50 seconds, 1 minute, 1.5 minutes, 2 minutes, 2.5 minutes, 3 minutes, 3.5 minutes, 4 minutes, 5 minutes, 10 minutes, 20 minutes, 30 minutes, 60 minutes, or 120 minutes, or for a time in a range defined by any two of the preceding values.

Some embodiments provide a process for reducing the level of acrylamide in a brewed roasted coffee product, including: brewing an herbal blend to form a brewed herbal blend product; brewing a roasted coffee to form a brewed coffee product; and combining the roasted coffee or the brewed coffee product with the herbal blend or the brewed herbal blend product to form a reduced acrylamide brewed coffee product, wherein the amount of acrylamide present in the reduced acrylamide brewed coffee product may be at least 10% lower than the amount of acrylamide present in a brewed coffee product brewed from the same roasted coffee under the same brewing conditions wherein the herbal blend is not added. In some embodiments, the amount of acrylamide present may be at least 50% lower than the amount of acrylamide present in a brewed coffee product brewed from the same coffee under the same brewing conditions wherein the herbal blend is not added. In some embodiments, the amount of acrylamide present may be from about 10% to about 50% lower than the amount of acrylamide present in a brewed coffee product brewed from the same coffee under the same brewing conditions wherein the herbal blend is not added. In some embodiments, the amount of acrylamide present may be at least 5%, 10%, 15%, 20%, 25%, 30%, 35%, 40%, 45%, 50%, or 55% lower than the amount of acrylamide present in a brewed coffee product brewed from the same coffee under the same brewing conditions wherein the herbal blend is not added, or a range defined by any two of the preceding values. In some embodiments of the process, the amount of acrylamide present may be at least 5%, 10%, 15%, 20%, 25%, 30%, 35%, 40%, 45%, or 50%, lower than the amount of acrylamide present in a brewed coffee product brewed from the same coffee wherein the herbal blend is not added. In some embodiments of the process, the brewing may include heating an aqueous mixture at a temperature of 55° C., 60° C., 65° C., 70° C., 75° C., 80° C., 85° C., 90° C., 95° C., or 100° C. or a temperature in a range defined by any two of the preceding values. In some embodiments of the process, the brewing may include heating an aqueous mixture for a time of at least, at least about, more than, or more than about, 5 seconds, 10 seconds, 20 seconds, 30 seconds, 40 seconds, 50 seconds, 1 minute, 1.5 minutes, 2 minutes, 2.5 minutes, 3 minutes, 3.5 minutes, 4 minutes, 5 minutes, 10 minutes, 20 minutes, 30 minutes, 60 minutes, or 120 minutes, or for a time in a range defined by any two of the preceding values.

In some embodiments of a process as disclosed and described herein, the roasted coffee and the herbal blend may be combined prior to brewing either the roasted coffee or the herbal blend, and the combined roasted coffee and herbal blend are brewed together. In some embodiments of a process as disclosed and described herein, the roasted coffee and herbal blend may be brewed separately, and the brewed coffee product is combined with the brewed herbal blend product. In some embodiments of a process as disclosed and described herein, the roasted coffee may be brewed to form a brewed coffee product and the herbal blend is brewed using the brewed coffee product. In some embodiments of a process as disclosed and described herein, the herbal blend may be brewed to form a brewed herbal blend product and the roasted coffee is brewed using the brewed herbal blend product. In some embodiments, the process provides a brewed coffee product where amount of acrylamide present may be at least 50% lower than the amount of acrylamide present in a brewed coffee product brewed from the same coffee under the same brewing conditions wherein the herbal blend is not added. In some embodiments, the process provides a brewed coffee product where the amount of acrylamide present may be from about 10% to about 50% lower than the amount of acrylamide present in a brewed coffee product brewed from the same coffee under the same brewing conditions wherein the herbal blend is not added. In some embodiments, the process provides a brewed coffee product where the amount of acrylamide present may be at least 5%, 10%, 15%, 20%, 25%, 30%, 35%, 40%, 45%, 50%, or 55% lower than the amount of acrylamide present in a brewed coffee product brewed from the same coffee under the same brewing conditions wherein the herbal blend is not added, or a range defined by any two of the preceding values. In some embodiments of a process as disclosed and described herein, the process may include heating an aqueous mixture at a temperature of 55° C., 60° C., 65° C., 70° C., 75° C., 80° C., 85° C., 90° C., 95° C., or 100° C. or a temperature in a range defined by any two of the preceding values. In some embodiments of a process as disclosed and described herein, the process may include heating an aqueous mixture for a time of at least, at least about, more than, or more than about, 5 seconds, 10 seconds, 20 seconds, 30 seconds, 40 seconds, 50 seconds, 1 minute, 1.5 minutes, 2 minutes, 2.5 minutes, 3 minutes, 3.5 minutes, 4 minutes, 5 minutes, 10 minutes, 20 minutes, 30 minutes, 60 minutes, or 120 minutes, or for a time in a range defined by any two of the preceding values.

The following examples will illustrate the effectiveness of this invention but it should be understood that these examples are intended to be purely exemplary and are not intended to limit the scope of the present invention.

### EXAMPLES

### Example 1

A decaf roast (Komoto Blend DKB-6; Ancora Coffee Roasters, Decaf Komoto Blend, 344 grams) was used as both a control blend and the base coffee blend to which a blend of Cacao Nibs 69 grams, Cinnamon Chips 5 grams, Elderberries 32 grams and Rosehip Powder 4 grams was added and thoroughly mixed (Star West Botanicals and Mountain Rose Herbs). The Komoto Blend was in roasted bean form which was coarsely ground. For portion control, samples of the control blend of Komoto (DKB-6) and the herbal blend/coffee blend (Healthy Café Decaf Blend DF-5) were made exactly in the right quantity to make one 16 oz portion of coffee. The samples were brewed at 195 degrees F. for four minutes in a special non-paper filter coffee brewer to reduce any contamination. The acrylamide results are for the brewed coffee from both the control blend and the herbal blend Healthy Café blend. As used herein, “ppb” means parts per billion by weight.

TABLE 1

| | Acrylamide | |
|---|---|---|
| Sample Used | Content | Change |
| Control Coffee (Komoto | 7.2 ppb | |
| Blend DKB-6) | | |
| Healthy Café Decaf Blend DF-5 | 5.3 ppb | 26.4% reduction |

Acrylamide analysis and certification of results by Covance Laboratories in Madison Wis. Acrylamide analysis followed the Formic acid extraction method and the acrylamide was determined in the sample extract using LC/MS/MS.

### Example 2

A Second roast of Komoto decaf coffee, as prepared in Example 1, was tested in the same manner, noted below are the test results.

TABLE 2

| | Acrylamide | |
|---|---|---|
| Sample Used | Content | Change |
| Control Coffee (Komoto | 6.2 ppb | |
| Blend DKB-02) | | |
| Healthy Café Decaf Blend DB-02 | <5.0 ppb | At least a 21.0% |
| | | reduction up to a |
| | | possible 100%* |

*Test limitation is 5.0 ppb.

### Example 3

In the same manner as the decaf roast, a bold coffee roast (BKTH-02; Ancora Coffee Roasters, Black Thunder Coffee 335 grams) was used as both a control blend and the base coffee blend to which a herbal blend of cacao nibs 67 grams, cinnamon chips 4grams, and elderberries 48 grams (Mountain Rose Herbs and Star West Botanicals) was added and thoroughly mixed producing a bold blend of herbal blend/coffee (Healthy Café Bold N Beautiful BB-02).

TABLE 3

| | Acrylamide | |
|---|---|---|
| Sample Used | Content | Change |
| Control Bold Roast BKTH-02 | 8.6 ppb | |
| Healthy Café Bold N | <5.0 ppb | At least a 43% |
| Beautiful BB-02 | | reduction up to a |
| | | possible 100%* |

### Example 4

An India Robusta Coffee (RC-7) Ancora Coffee Roasters, Indian Robusta Coffee 87 grams was used as both a control blend and the base coffee blend to which an herbal blend of cacao nibs 5 grams, cinnamon chips 2 grams, rosehip powder 1 grams, (Mountain Rose Herbs and Star West Botanicals) was added and thoroughly mixed producing a Healthy Café Robusta Blend (RB-8).

TABLE 4

| | Acrylamide | |
|---|---|---|
| Sample Used | Content | Change |
| Control Robusta Roast RC-7 | 17.5 ppb | |
| Healthy Café Robusta Blend | 12.1 ppb | 30.9% reduction |
| RB-8 | | |

### Example 5

A can of Folgers Classic ground coffee 70grams (lot #2 231 209 17:48 01) was purchased as the control blend (FC-01) for a branded coffee test. A herbal blend of A herbal blend of Cacoa nibs 4 grams, Elderberries 2 grams and Rosehip 1 gram, Cinnamon 1 gram (Mountain Rose Herbs and Star West Botanicals) was added to the Folgers Classic ground coffee and thoroughly mixed producing a Healthy Café Folgers Blend (FB-01). As before these samples were sent to Covance Laboratories for brewing and testing.

TABLE 5

| | Acrylamide | |
|---|---|---|
| Sample Used | Content | Change |
| Folgers Classic Coffee | 6.1 ppb | |
| Healthy Café Folgers Blend | 5.1 ppb | 16.4% reduction |

### Example 6

Focus groups and individual taste tests on National Brands of ground coffee achieved a significant improvement in the taste properties when the herbal blended mixture of the National Brand was compared to the original National Brand ground coffee.

A group of nine individuals were assembled to taste test five different blends of coffee. Each individual was given five cups of coffee, each marked with a letter, and were told to evaluate and rank the cups of coffee 1 through 5 as to their preference in the overall taste aspects of the blend. Within these five cups were one cup of original Maxwell House dark roast, lot #01may2013j5d1205, one cup original Folgers Classic roast medium, lot #2 231 209 17:48 01, and two other cups of herbal blends using the original ground Maxwell House dark roast (6.0 Roast) 55 grams, Cacao 5 grams, Sambucus 4 grams, Cinnamon 1.5 grams, and also served was Maxwell House dark roast (6.7 Roast) 55 grams, Cacao 6 grams, Elderberry 5 grams, Cinnamon 1 gram. Also included was an herbal blend of Indian Robusta coffee (see Example 4).

Results:

In comparing the Original Maxwell house blend to the two herbal blends of Maxwell House, 6 people out of nine (67%) chose a herbal blend Maxwell House blend over the original Maxwell House, one rated both equal. Interestingly 7 people out of nine (78%) chose the herbal blend Robusta blend as their first or second choice.

### Example 7

In another group of seven individuals, each were given three cups of coffee, each marked with a letter. They were told to evaluate and rank the cups of coffee 1 through 3 as to their preference in the overall taste aspects of the blend. One cup was Original Folgers Classic Roast Medium, lot #2 231 209 17:48 01. (FB-01) Folgers Classic ground coffee 70grams (lot #2 231 209 17:48 01) was used as the control blend (FC-01) for a branded coffee test. A herbal blend of Cacoa nibs 4 grams, Elderberries 2 grams and Rosehip 1 gram, Cinnamon 1 gram (Mountain Rose Herbs and Star West Botanicals) was added to the Folgers Classic ground coffee and thoroughly mixed producing a Healthy Café Folgers Blend (FB-01) using the Original Folgers Classic Roast Medium (see Example 5) as the base coffee. Also served was a Original Folgers Classic Roast Medium, lot #2 231 209 17:48 01 (FB-02), where Folgers Classic ground coffee 35 grams, Cacao 1.5 grams, Elderberry 1 gram, Rosehip Powder 0.5 grams (Mountain Rose Herbs and Star West Botanicals) was added to the Folgers Classic ground coffee and thoroughly mixed producing a Healthy Café Folgers Blend (FB-02)

Results:

In comparing the Original Folgers Classic Roast to the two herbal blends of Folgers Classic Roast, 6 people out of 7 (86%) chose a herbal blend Folgers blend over the original Folgers Classic Roast. One ranked both equal. Five out of the seven (71%) chose the same herbal blend as their favorite.

### Example 8

In a group of eight individuals, each were given three cups of coffee, each marked with a letter. They were told to evaluate and rank the cups of coffee 1 through 3, as to their preference in the overall taste aspects of the blend. One cup was Starbucks House Blend, the other two were varying blends of herbal blend coffee using the Original Starbucks House Blend as the base coffee. (SB- 01) Original Starbucks House Blend 80 grams, Cacao 4.5 grams, Elderberry 3.5 grams, Hibiscus 1.5 grams (SB-01), and (SB-02) Original Starbucks House Blend 50 grams, Cacao 3.5 grams, Elderberry 2 grams, Rose Hip Powder 0.5 grams (SB-02) were served.

Results:

In comparing the Original Starbucks House Roast to the two herbal blends of Starbucks House blend, 6 people out of 8 (75%) chose a herbal blend Starbucks blend over the original Starbucks House blend.

### Example 9

Various compositions were made to determine the reduction of acrylamide in coffee products. A can of Folgers Classic ground coffee (lot #2 231 209 17:48 01) was purchased as the control blend (FC-01) for a branded coffee test. The compositions shown in Table 6 included from about 89% coffee to about 91% coffee. The compositions were compared to coffee without the additional herbs included to determine percent reduction of acrylamide.

TABLE 6

| | RB-8 H.C. | RSTB-02 H.C. | FB-01 H.C. |
|---|---|---|---|
| Components of | Robusta | Robusta | Folgers |
| Blend | Blend | Blend | Blend |
| Coffee | 91.10% | 91.10% | 89.70% |
| Elder Berries | | | 2.60% |
| Cacoa Nibs | 5.20% | 5.20% | 5.10% |
| Rosehips Powder | 1.10% | 1.10% | 1.3% |
| Cinnamon | 2.60% | 2.60% | 1.3% |
| Acrylamide | 30.9% | At least 14.0% | 16.40% |
| Reduction | | | |

1. A coffee composition comprising: 55% or more by weight roasted unbrewed coffee by weight; at least 3% by weight cacao ; and at least 0.5% by weight of an herbal component selected from the group consisting of sambucus, rosehips, hibiscus, ziziphus fruit, and a combination thereof.

2. A coffee composition comprising: 55% or more by weight roasted unbrewed coffee by weight; at least 3% by weight of a first herbal component selected from cacao, barley, rice, gelatin, and a combination thereof; and at least 0.5% by weight of a second herbal component selected from the group consisting of sambucus, rosehips, hibiscus, ziziphus fruit, and a combination thereof.

3. The coffee composition of claim 2, wherein the composition does not include more than 15%, 10%, 8%, or 6% black or red tea by weight.

4. The coffee composition of claim 2, wherein the composition does not include more than 10%, 8%, 7%, 6%, or 5% cinnamon by weight.

5. The coffee composition of claim 2, wherein the roasted unbrewed coffee is robusta coffee.

6. The coffee composition of claim 2, wherein the roasted unbrewed coffee is arabica coffee.

7. The coffee composition of claim 2, wherein the roasted unbrewed coffee is a blend of robusta and arabica coffee, wherein, the amount of robusta coffee in the blend of robusta and arabica coffee is at least 5%, 10%, 20%, 30%, 40%, 50%, 60%, 70%, 80%, 90%, or 95% by weight.

8. The coffee composition of claim 2, wherein the roasted unbrewed coffee comprises ground roasted coffee.

9. The coffee composition of claim 2, wherein the roasted unbrewed coffee comprises whole bean roasted coffee.

10. The coffee composition of claim 2, wherein the coffee composition coffee comprises at least 3%, 4%, 5%, 6%, 7%, 8%, 9%, 10%, 11%, 12%, 13%, 14%, or 15% by weight cacao.

11. The coffee composition of claim 10, wherein the cacao is a cacao extract, and the amount of extract is the dry, unextracted weight equivalent.

12. The coffee composition of claim 2, wherein the coffee composition coffee comprises at least 0.5%, 0.7%, 1.0%, 1.5%, 2.0%, 2.5%, 3.0%, or 3.5% by weight sambucus.

13. The coffee composition of claim 12, wherein the sambucus is a sambucus extract, and the amount of extract is the dry, unextracted weight equivalent.

14. The coffee composition of claim 2, wherein the coffee composition coffee comprises at least 0.1%, 0.2%, 0.3%, 0.4%, 0.5%, 0.7%, 1.0%, 1.5%, 2.0%, 2.5%, 3.0%, or 3.5% by weight rosehips.

15. The coffee composition of claim 14, wherein the rosehips is a rosehips extract, and the amount of extract is the dry, unextracted weight equivalent.

16. The coffee composition of claim 2, wherein the coffee composition coffee comprises at least 0.5%, 0.7%, 1.0%, 1.5%, 2.0%, 2.5%, 3.0%, or 3.5% by weight hibiscus.

17. The coffee composition of claim 16, wherein the hibiscus is a hibiscus extract, and the amount of extract is the dry, unextracted weight equivalent.

18. The coffee composition of claim 2, wherein the coffee composition coffee comprises at least 0.5%, 0.7%, 1.0%, 1.5%, 2.0%, 2.5%, 3.0%, or 3.5% by weight ziziphus fruit.

19. The coffee composition of claim 18, wherein the ziziphus fruit is a ziziphus fruit extract, and the amount of extract is the dry, unextracted weight equivalent.

20. The coffee composition of claim 2, wherein the coffee composition further comprises one or more herbs selected from the group consisting of Astragulus Root, Barley, Black Tea, Cardamon Pods, Cinnamon, Cloves, Star Anise, Nutmeg, English Breakfast Tea, Earl Grey Tea, Gelatin, Green Tea, Ginger root, Ginseng, Honeybush, Jasmine Flower, Lavender flower, Lemon Balm, Lemon Grass, Licorice root, Logan Fruit, Lotus Seed, Orange Peel, Passion Flower, Peppermint, Rice, Pomegranite, Rose, Sencha, Spearmint, Stevia Leaf and Valerian Root.

21. A process for brewing a roasted coffee, comprising:
a. providing the coffee composition of claim 2; and
b. brewing the coffee composition to form a brewed coffee product.

22. A brewed coffee product comprising:
a high temperature aqueous extraction components of roasted coffee; and
a high temperature aqueous extraction components of an herbal blend, wherein the herbal blend comprises at least 20% by weight cacao ; and at least 0.003% by weight of one selected from the group consisting of sambucus, rosehips, hibiscus, and ziziphus fruit.

23. A process for a brewing a roasted coffee, comprising:
a. brewing an herbal blend to form a brewed herbal blend product, wherein the herbal blend comprises at least 20% by weight cacao ; and at least 0.003% by weight of one selected from the group consisting of sambucus, rosehips, hibiscus, and ziziphus fruit;
b. brewing a roasted coffee to form a brewed coffee product; and
c. combining the roasted coffee or the brewed coffee product with the herbal blend or the brewed herbal blend product to form a brewed coffee product.

24. The process of claim 23, wherein the roasted coffee and the herbal blend are combined prior to brewing either the roasted coffee or the herbal blend, and the combined roasted coffee and herbal blend are brewed together.

25. The process of claim 23, wherein the roasted coffee and herbal blend are brewed separately, and the brewed coffee product is combined with the brewed herbal blend product.

26. The process of claim 23, wherein the roasted coffee is brewed to form a brewed coffee product and the herbal blend is brewed using the brewed coffee product.

27. The process of claim 23, wherein the herbal blend is brewed to form a brewed herbal blend product and the roasted coffee is brewed using the brewed herbal blend product.

28. The process of claim 23, wherein the herbal blend or brewed herbal blend product are in contact with the roasted coffee or brewed roasted coffee product in an aqueous solvent at a temperature ranging from 50 to 100° C. for at least 1 to 10 minutes.

29. A brewed coffee product from the process of claim 23.

30. The composition or process of claim 23, wherein the brewed coffee product is placed in a container configured for immediate consumption.

31. The composition or process of claim 23, wherein the brewed coffee product is placed in a sealed container configured to store the brewed coffee product for at least one week.

32. The composition or process of claim 23, wherein the brewed coffee product is freeze dried or spray dried.

33-67. (canceled)
